(19) United States
(12) Patent Application Publication
(10) Pub. No.: US 2012/0141112 A1
(43) Pub. Date: Jun. 7, 2012

(54) SHUTTER BLADE AND SHUTTER USING THE SAME

(75) Inventors: LI QIAN, Beijing (CN); YU-QUAN WANG, Beijing (CN); CHEN FENG, Beijing (CN); LIANG LIU, Beijing (CN)

(73) Assignee: BEIJING FUNATE INNOVATION TECHNOLOGY CO., LTD., Beijing (CN)

(21) Appl. No.: 13/228,743

(22) Filed: Sep. 9, 2011

(30) Foreign Application Priority Data
Dec. 7, 2010 (CN) 201010576907.4

(51) Int. Cl. G03B 9/10; G03B 9/08; B82B 1/00; B82Y 20/00

(52) U.S. Cl. 396/497; 396/452; 977/742; 977/902

(57) ABSTRACT

A shutter blade is provided. The shutter blade includes a carbon nanotube structure. The carbon nanotube structure includes a plurality of carbon nanotubes. A shutter using the shutter blade is also provided. The camera shutter includes a blade structure, two drive units, a substrate defining an aperture, and a connection unit located on the substrate. The blade structure is connected with the connection unit and controls the aperture to be covered or uncovered. The blade structure includes at least two the above-mentioned shutter blades. The drive units are located on a same side of the substrate and configured to drive the blade structure to rotate clockwise or counterclockwise.

### RELATED APPLICATIONS

This application claims all benefits accruing under 35 U.S.C. §119 from China Patent Application No. 201010576907.4, filed on Dec. 7, 2010 in the China Intellectual Property Office, the disclosures of which are incorporated herein by reference.

### BACKGROUND

1. Technical Field

The present disclosure relates to a shutter blade and a shutter using the same.

2. Discussion of Related Art

Shutter blades are an important element in a shutter of a camera and can affect shutter speed. Materials of shutter blades are usually alloys, such as steel. Alloys are strong enough for use in shutters, but are heavy, which limits shutter speed.

What is needed, therefore, is to provide a shutter blade and a shutter using the same with high shutter speed.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a top view of one embodiment of a shutter.

FIG. 2 is a cross-sectional view of one embodiment of a shutter blade.

FIG. 3 shows a scanning electron microscope (SEM) image of a drawn carbon nanotube film.

FIG. 4 shows an SEM image of a pressed carbon nanotube film.

FIG. 5 shows an SEM image of a flocculated carbon nanotube film.

FIG. 6 is a cross-sectional view of one embodiment of a shutter blade.

FIG. 7 is a cross-sectional view of one embodiment of a shutter blade.

FIG. 8 shows an SEM image of an untwisted carbon nanotube wire.

FIG. 9 shows an SEM image of a twisted carbon nanotube wire.

FIG. 10 is a cross-sectional view of one embodiment of a shutter blade.

FIG. 11 is a cross-sectional view of one embodiment of a shutter blade.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

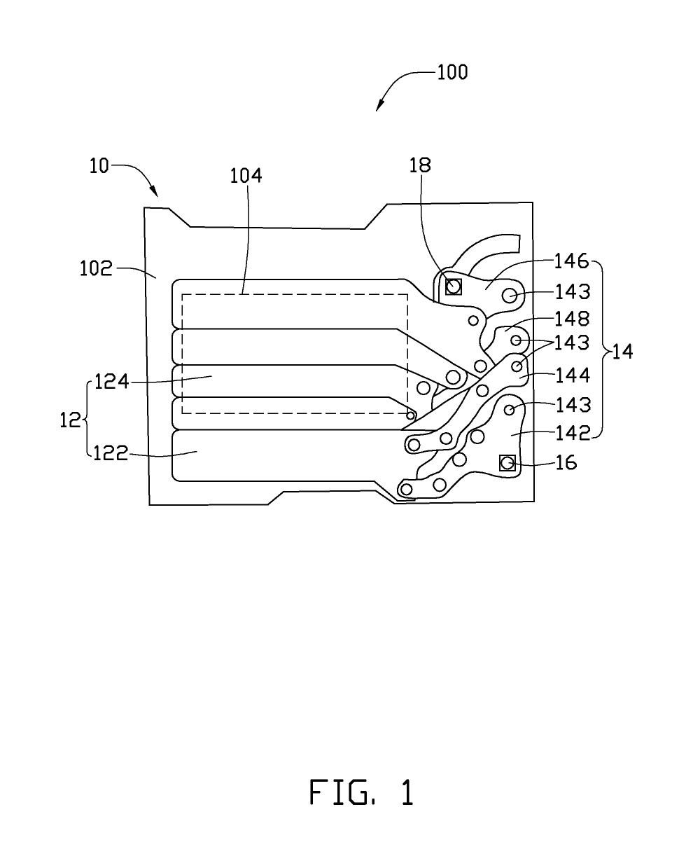

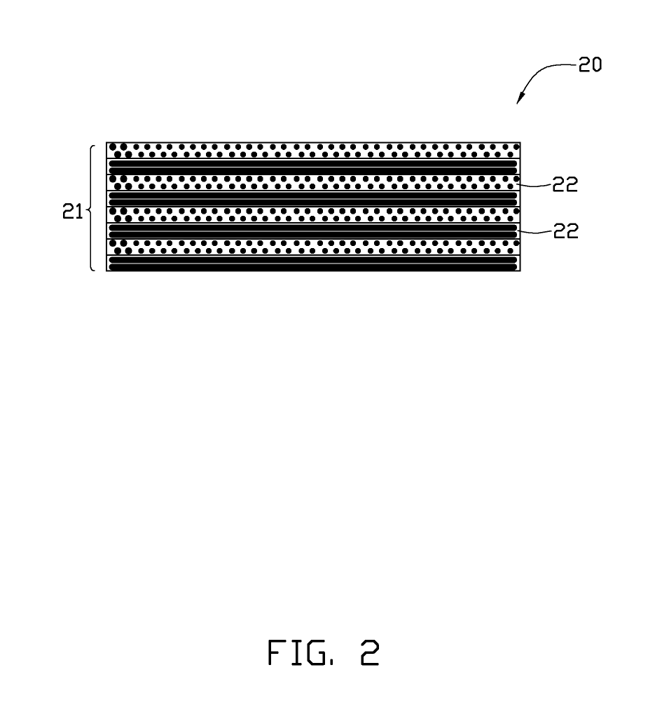

Referring to FIGS. 1 and 2, a camera shutter 100 of one embodiment is provided. The shutter 100 is used to control exposure time. Exposure of a photosensitive element (not shown) in a camera (not shown) with the shutter 100 can be controlled by the opening and closing of the shutter 100. The shutter 100 includes a substrate 10, a blade structure 12, a connection unit 14, a first drive unit 16, and a second drive unit 18.

The substrate 10 is configured to support the blade structure 12, the connection unit 14, the first drive unit 16, and the second drive unit 18. The substrate 10 includes a body 102 defining an aperture 104. The body 102 can be a flat panel substantially parallel to the photosensitive element of the camera. In one embodiment, the aperture 104 is a through hole defined at the center of the body 102. When the shutter 100 is used, an amount of light transits the aperture 104 and irradiates the photosensitive element. When the shutter 100 is not in use, the blade structure 12 covers the aperture 104 to prevent light from irradiating the photosensitive element. A shape of the aperture 104 can be selected as desired. The shape of the aperture 104 can be circular, polygonal, such as rectangular, triangular, or any other desired shapes. In one embodiment, the shape of the aperture 104 is rectangular.

The first and second drive units 16, 18 are configured to drive the blade structure 12 to rotate clockwise or counterclockwise. The first and second drive units 16, 18 are located on a same side of the body 102 and are connected to the connection unit 14.

The connection unit 14 connects the blade structure 12 to the body 102. The connection unit 14 includes a first arm 142, a first subsidiary arm 144, a second arm 146, a second subsidiary arm 148, and a number of rotation shafts 143. The first arm 142 is connected to the body 102 via the first drive unit 16. The second arm 146 is connected to the body 102 by the second drive unit 18. The first and second subsidiary arms 144, 148 are respectively connected to the body 102 by some of the rotation shafts 143. The second drive unit 18 can drive the second arm 146 and the second subsidiary arm 148 to rotate around their corresponding rotation shafts 143, clockwise or counterclockwise.

The blade structure 12 is used to cover or uncover the aperture 104. The blade structure 12 includes a first shutter unit 122 and a second shutter unit 124. Both the first and second shutter units 122, 124 include at least one shutter blade 20. The shape and the number of the shutter blades 20 in the first and second shutter units 122, 124 are not limited. In one embodiment, the first and second shutter units 122, 124 each include four shutter blades 20. The first shutter unit 122 connects with the first arm 142 and the first subsidiary arm 144. The first shutter unit 122 can be driven to move along a straight line by the first drive unit 16, so that the aperture 104 can be covered or uncovered. The second shutter unit 124 connects with the second arm 146 and the second subsidiary arm 148. The second shutter unit 124 can be driven to move along a straight line by the second drive unit 18, so that the aperture 104 can be covered or uncovered.

When the shutter 100 is in use, the second drive unit 18 can drive the second arm 146 and the second subsidiary arm 148 to rotate around their corresponding rotation shafts 143 clockwise, and the second arm 146 and the second subsidiary arm 148 move the four shutter blades 20 of the second shutter blade unit 124 along a straight line. Thus, the aperture 104 is uncovered. After a predetermined exposure time, the first drive unit 16 can drive the first arm 142 and the first subsidiary arm 144 to rotate around their corresponding rotation shafts 143 clockwise, and the first arm 142 and the first subsidiary arm 144 move the first shutter blade unit 122 along a straight line. Thus, the four shutter blades 20 of the first shutter blade unit 122 cover the aperture 104 to finish the exposure of the photosensitive element.

It can be understood that the structures and the actions of the shutter blades 20 in the shutter 100 are not limited to those of the embodiment. The shutter blades 20 can use other structures and actions, as long as the shutter blades 20 can be used to control exposure of the photosensitive element.

The shapes of the shutter blade 20 can be selected as desired. Thicknesses of the shutter blades 20 can range from about 1 micrometer (μm) to about 200 μm. In one embodiment, the thicknesses of the shutter blades 20 are in a range from about 5 μm to 20 μm. The transparency of each shutter blade 20 to visible light is less than or equal to 1%.

Each shutter blade 20 includes a number of carbon nanotubes arranged orderly or disorderly. The carbon nanotubes are closely combined with each other via van der Waals force. The shutter blade 20 can be a carbon nanotube structure 21 having a flat structure. The carbon nanotube structure 21 includes a plurality of carbon nanotubes joined by van der Waals force. The carbon nanotubes can be located on the same surface or different surfaces. In one embodiment, the carbon nanotubes in each shutter blade 20 are substantially parallel to a surface of the shutter blade 20.

The carbon nanotube structure 21 is a free-standing structure. That is, the carbon nanotube structure 21 can keep its special shape without being supported on a surface of a substrate. In one embodiment, the shutter blade 20 is the carbon nanotube structure 21 made of pure carbon nanotubes. The carbon nanotubes in the shutter blade 20 are not subjected to acid treatments or other functional modification and do not include carboxyl groups or other functional groups. In one embodiment, each shutter blade 20 is a sheet-shaped free-standing structure made of a number of carbon nanotubes, and adjacent carbon nanotubes in the carbon nanotubes are closely joined by van der Waals force.

The carbon nanotube structure 21 can include at least one carbon nanotube film. The number of the carbon nanotube films is not limited, however the thickness of the carbon nanotube structure 21 range from about 1 μm to about 200 μm, to ensure the transparency of the carbon nanotube structure 21 to visible light is less than or equal to 1%. If the carbon nanotube structure 21 includes a number of stacked carbon nanotube films, adjacent carbon nanotube films are closely combined with each other by van der Waals force.

Referring to FIG. 2, in the embodiment, the shutter blade 20 is a carbon nanotube structure 21 with a thickness of about 5 μm, which is made by stacking 50 layers of drawn carbon nanotube films one by one. Each of the drawn carbon nanotube film has a thickness of about 0.5 μm. No significant amount of light can pass through the shutter blade 20. The shutter blade 20 is a thin sheet-shaped structure with a certain strength.

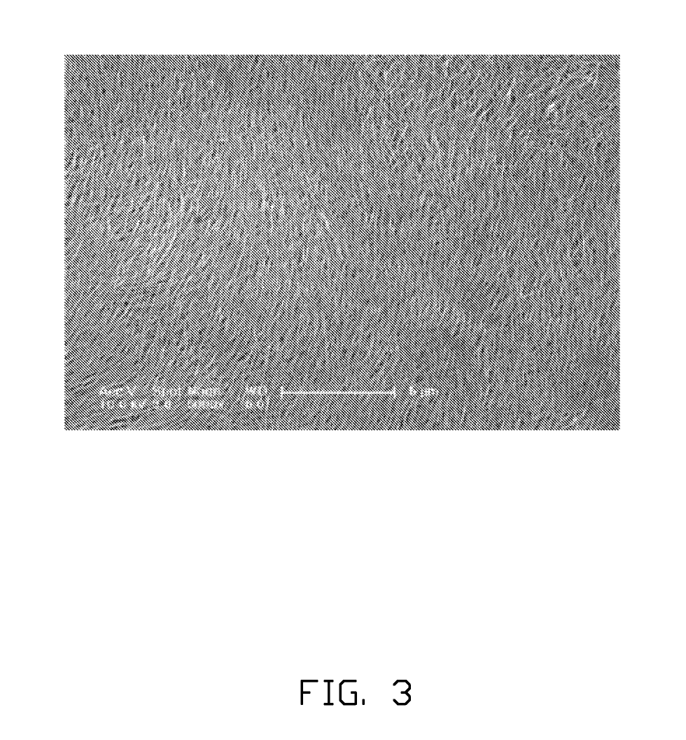

Referring to FIG. 3, the drawn carbon nanotube film is formed by drawing a film from a carbon nanotube array. Examples of the drawn carbon nanotube film are taught by U.S. Pat. No. 7,045,108 to Jiang et al. The thickness of the drawn carbon nanotube film can be in a range from about 0.5 nanometers (nm) to about 100 μm.

The drawn carbon nanotube film includes a plurality of carbon nanotubes that are arranged substantially parallel to a surface of the drawn carbon nanotube film. A large number of the carbon nanotubes in the drawn carbon nanotube film can be oriented along a preferred orientation, meaning that a large number of the carbon nanotubes in the drawn carbon nanotube film are arranged substantially along the same direction. An end of one carbon nanotube is joined to another end of an adjacent carbon nanotube arranged substantially along the same direction by van der Waals attractive force. A small number of the carbon nanotubes are randomly arranged in the drawn carbon nanotube film, and has a small if not negligible effect on the larger number of the carbon nanotubes in the drawn carbon nanotube film arranged substantially along the same direction. It can be appreciated that some variation can occur in the orientation of the carbon nanotubes in the drawn carbon nanotube film. Microscopically, the carbon nanotubes oriented substantially along the same direction may not be perfectly aligned in a straight line, and some curve portions may exist. It can be understood that contact between some carbon nanotubes located substantially side by side and oriented along the same direction cannot be totally excluded.

More specifically, the drawn carbon nanotube film can include a plurality of successively oriented carbon nanotube segments joined end-to-end by van der Waals attractive force therebetween. Each carbon nanotube segment includes a plurality of carbon nanotubes substantially parallel to each other, and joined by van der Waals attractive force therebetween. The carbon nanotube segments can vary in width, thickness, uniformity, and shape. The carbon nanotubes in the drawn carbon nanotube film are also substantially oriented along a preferred orientation. The width of the drawn carbon nanotube film relates to the carbon nanotube array from which the drawn carbon nanotube film is drawn.

In the shutter blade 20 including stacked drawn carbon nanotube films, an angle can exist between the orientation directions of the carbon nanotubes in at least two drawn carbon nanotube films, and can range from about 0 degrees to about 90 degrees, such as 15 degrees, 30 degrees or 60 degrees. In one embodiment, the angle can exist between the axial extending directions of the carbon nanotubes in each two adjacent drawn carbon nanotube films, and can range from about 0 degrees to about 90 degrees. In one embodiment, the angle is about 90 degrees.

The carbon nanotubes have good light absorption property; therefore, the shutter blade 20 can have good light absorption ability even when relatively thin. Specifically, the transparency of the shutter blade 20 can be less than or equal to 1% for visible light, even if the thickness of the shutter blade 20 is in a range from about 1 μm to about 200 μm. Because the carbon nanotubes can absorb light, when the shutter blade 20 covers the aperture 104, it also can decrease reflectivity of the shutter blade 20.

In addition, the carbon nanotubes have good mechanical property and good durability. The tensile strength of the carbon nanotubes is about 100 times greater than the tensile strength of steel, and the elastic modulus of the carbon nanotubes is substantially equal to that of diamond. Even with relatively reduced thickness, the shutter blade 20 can still have the same level of mechanical properties of the traditional shutter blades.

The shutter blade 20 can be a free-standing carbon nanotube structure, and formed by the carbon nanotubes via van der Waals force, so that the shutter blade 20 can keep its shape even while being so thin. In addition, the carbon nanotubes are lightweight, and the density of the carbon nanotubes is about one sixth of that of steel. Therefore, the weight of the shutter blade 20 is light. The shutter blade 20 and the shutter 100 using the same can be convenient to be used in wide variety of photographic devices, and they can reduce the drive force and braking force needed to operate the shutter blade. Thus, camera batteries will last longer. In addition, the angles defined by the carbon nanotubes in adjacent drawn carbon nanotube films are about 90 degrees, therefore, the shutter blade 20 is strong along any direction.

A method for making the shutter blade 20 includes:

providing a number of drawn carbon nanotube films;

stacking the drawn carbon nanotube films to form the carbon nanotube structure 21;

treating the carbon nanotube structure 21 with an organic solvent, to closely combine adjacent drawn carbon nanotube films; and

stamping the treated carbon nanotube structure 21 to form the shutter blade 20.

The carbon nanotube structure 21 is not limited to the drawn carbon nanotube films, it also can be other carbon nanotube films, such as pressed carbon nanotube films, flocculated carbon nanotube films, or any combination of the three kinds of carbon nanotube films.

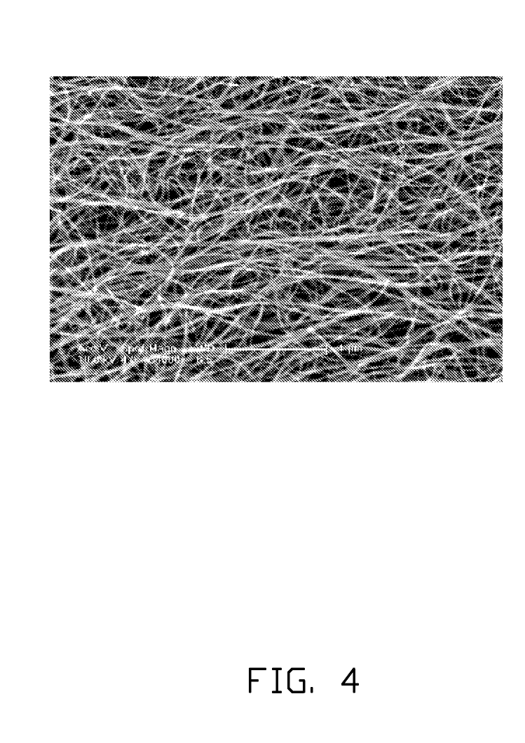

Referring to FIG. 4, the pressed carbon nanotube film is formed by pressing a carbon nanotube array down on the substrate. The carbon nanotubes in the pressed carbon nanotube array are arranged along a same direction or along different directions. The carbon nanotubes in the pressed carbon nanotube array can rest upon each other. Adjacent carbon nanotubes are attracted to each other and combined by van der Waals attractive force. An angle between a primary alignment direction of the carbon nanotubes and a surface of the pressed carbon nanotube array is about 0 degrees to approximately 15 degrees. The greater the pressure applied, the smaller the angle obtained. If the carbon nanotubes in the pressed carbon nanotube array are arranged along different directions, the carbon nanotube structure can be isotropic. Here, “isotropic” means the carbon nanotube film has properties identical in all directions substantially parallel to a surface of the carbon nanotube film. The thickness of the pressed carbon nanotube array can range from about 0.5 nm to about 1 mm. The length of the carbon nanotubes can be larger than 50 μm. Examples of the pressed carbon nanotube film are taught by US PGPub. 20080299031A1 to Liu et al.

If the thickness of a single pressed carbon nanotube film is thick enough, the shutter blade 20 can be composed of a single pressed carbon nanotube film. If the thickness of the single pressed carbon nanotube film is relatively thin, the shutter blade 20 can be composed of a number of stacked pressed carbon nanotube films. Adjacent pressed carbon nanotube films are combined with each other by van der Waals force. The arrangements of the carbon nanotubes in the shutter blade 20 are decided by the arrangements of the carbon nanotubes in each pressed carbon nanotube film. In one embodiment, most of the carbon nanotubes in each pressed carbon nanotube film are substantially arranged along a same direction, and the axes of the carbon nanotubes in each pressed carbon nanotube film are substantially parallel to a surface of the corresponding pressed carbon nanotube film, an angle between the aligned directions of the carbon nanotubes in two adjacent pressed carbon nanotube films can range from about 0 degrees to about 90 degrees.

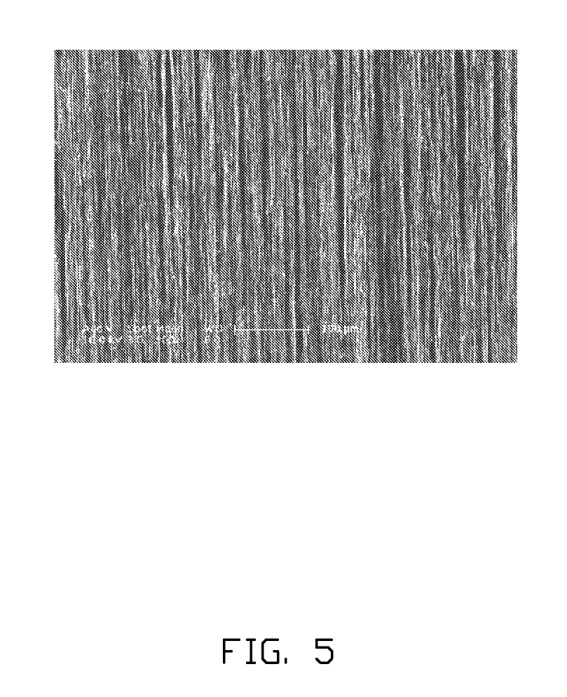

Referring to FIG. 5, the flocculated carbon nanotube film is formed by a flocculating method. The flocculated carbon nanotube film can include a plurality of long, curved, disordered carbon nanotubes entangled with each other. A length of the carbon nanotubes can be greater than 10 centimeters. In one embodiment, the length of the carbon nanotubes is in a range from about 200 μm to about 900 μm. Furthermore, the flocculated carbon nanotube film can be isotropic. The carbon nanotubes can be substantially uniformly distributed in the carbon nanotube film. The adjacent carbon nanotubes are acted upon by the van der Waals attractive force therebetween, thereby forming an entangled structure with micropores defined therein. The thickness of the flocculated carbon nanotube film can range from about 1 μm to about 1 millimeter (mm). In one embodiment, the thickness of the flocculated carbon nanotube film is about 100 μm.

If the flocculated carbon nanotube film is thick enough, the shutter blade 20 can be a single flocculated carbon nanotube film. If the flocculated carbon nanotube film is relatively thin, the shutter blade 20 can be a number of stacked flocculated carbon nanotube films, and adjacent flocculated carbon nanotube films are joined by van der Waals force.

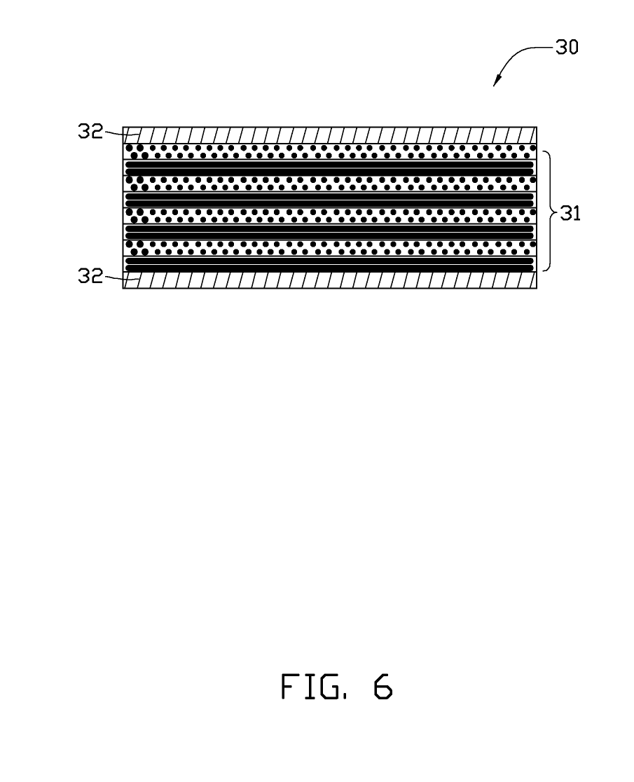

The structures and materials of the shutter blades in the shutter 100 are not limited to those of the shutter blades 20. Referring to FIG. 6, a shutter blade 30 of one embodiment is provided. The shutter blade 30 can be substituted for the shutter blade 20 in the shutter 100. The shutter blade 30 can include a carbon nanotube structure 31 and a coating layer 32 coated on the carbon nanotube structure 31. The thickness of the coating layer 32 can range from about 1 μm to 10 μm. The material of the coating layer 32 can be fluorinated polyolefin, polyimide (PI), polyphenylene thioether (PPS), or any combination thereof. In one embodiment, the coating layer 32 is made of fluorinated polyolefin, and the thickness of the coating layer 32 is about 1 μm.

The coating layer 32 coated on the shutter blade 20 can act as lubricant, which can reduce friction between adjacent shutter blades during operation. Thus, shutter speeds and wearability of the shutter blades can be improved.

The carbon nanotube structure 31 discussed here can have substantially the same structure as the carbon nanotube structure 21 disclosed above.

In one embodiment, the shutter blade 30 is made by coating a fluorinated polyolefin layer on the surfaces of the carbon nanotube structure 31.

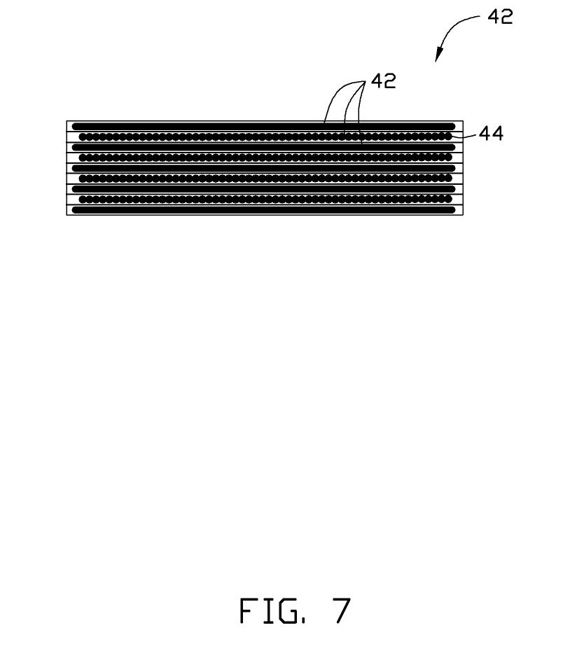

Referring to FIG. 7, a shutter blade 40 of one embodiment is provided. The shutter blade 40 includes a carbon nanotube structure. The carbon nanotube structure includes a number of carbon nanotube wires 44. Some of the carbon nanotube wires 44 are substantially parallel to each other to form a carbon nanotube layer 42. The carbon nanotube wires 44 in the carbon nanotube layer are arranged side by side, and adjacent carbon nanotube wires 44 are combined with each other by van der Waals force. In one embodiment, the thickness of the shutter blade 40 is about 30 μm, and the shutter blade 40 is a thin sheet-shaped structure with a certain strength.

In one embodiment, the shutter blade 40 includes a number of stacked carbon nanotube layers 42. Adjacent carbon nanotube layers 42 are joined by van der Waals force. In one embodiment, the carbon nanotube wires 44 along the axial extending directions thereof in at least two carbon nanotube layers 42 can be intercrossed with each other to form an angle ranging from about 0 degrees to about 90 degrees. In one embodiment, the angle between the carbon nanotube wires 44 in adjacent carbon nanotube layers 42 can range from about 0 degrees to about 90 degrees. In one embodiment, the angle is about 90 degrees.

It is noted that, the carbon nanotube wires 44 in adjacent carbon nanotube layers 42 in the shutter blade 40 are intercrossed with each other, thus, the shutter blade 40 can be prevented from cracking along any direction, and can be strong along any direction, which is substantially parallel to the surface of the shutter blade 40.

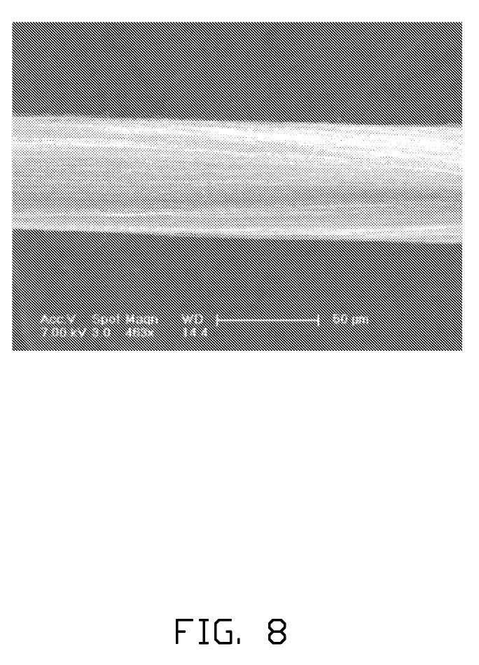

The carbon nanotube wire can be untwisted or twisted. Referring to FIG. 8, treating the drawn carbon nanotube film with a volatile organic solvent can obtain the untwisted carbon nanotube wire. In one embodiment, the organic solvent is applied to soak the entire surface of the drawn carbon nanotube film. During the soaking, adjacent substantially parallel carbon nanotubes in the drawn carbon nanotube film will bundle together, due to the surface tension of the organic solvent as it volatilizes. Thus the drawn carbon nanotube film will be shrunken into an untwisted carbon nanotube wire. The untwisted carbon nanotube wire includes a plurality of carbon nanotubes substantially oriented along a same direction (i.e., a direction along the length direction of the untwisted carbon nanotube wire). The carbon nanotubes are substantially parallel to the axis of the untwisted carbon nanotube wire. In one embodiment, the untwisted carbon nanotube wire includes a plurality of successive carbon nanotubes joined end to end by van der Waals attractive force therebetween. The length of the untwisted carbon nanotube wire can be arbitrarily set as desired. A diameter of the untwisted carbon nanotube wire ranges from about 0.5 nm to about 100 μm. Examples of the untwisted carbon nanotube wire are taught by US Patent Application Publication US 2007/0166223 to Jiang et al.

Other characteristics of the shutter blade 40 are substantially the same as the shutter blade 20 disclosed above.

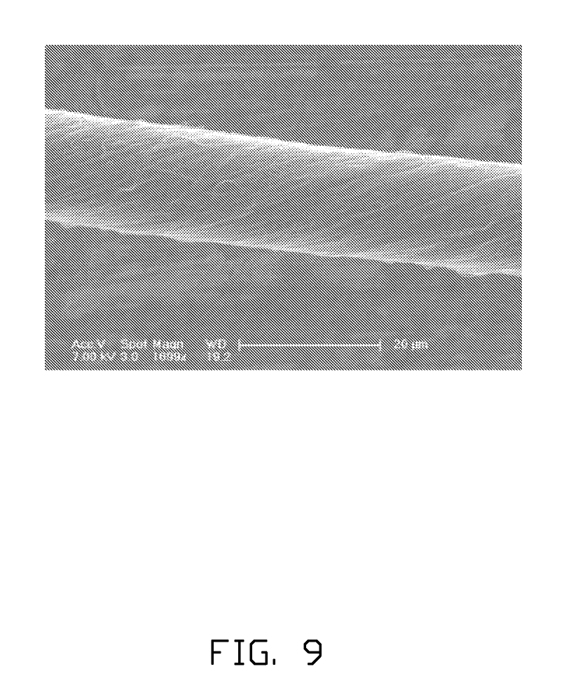

Referring to FIG. 9, the twisted carbon nanotube wire can be obtained by twisting a drawn carbon nanotube film using a mechanical force to turn the two ends of the drawn carbon nanotube film in opposite directions. The twisted carbon nanotube wire includes a plurality of carbon nanotubes helically oriented around an axial direction of the twisted carbon nanotube wire. In one embodiment, the twisted carbon nanotube wire includes a plurality of successive carbon nanotubes joined end to end by van der Waals attractive force therebetween. The length of the carbon nanotube wire can be set as desired. A diameter of the twisted carbon nanotube wire can be from about 0.5 nm to about 100 μm.

The twisted carbon nanotube wire can be treated with a volatile organic solvent, before or after being twisted. After being soaked by the organic solvent, the adjacent substantially parallel carbon nanotubes in the twisted carbon nanotube wire will bundle together, due to the surface tension of the organic solvent when the organic solvent volatilizes. The specific surface area of the twisted carbon nanotube wire will decrease, and the density and strength of the twisted carbon nanotube wire will be increased.

The shutter blade 40 can be made by the following steps:

providing a number of carbon nanotube wires 44;

forming a first carbon nanotube layer and a second carbon nanotube layer, wherein the forming the first carbon nanotube layer includes arranging carbon nanotube wires 44 side by side along a first direction, and the forming the second carbon nanotube layer includes placing carbon nanotube wires 44 side by side along a second direction that is substantially perpendicular to the first direction;

layering a plurality of first carbon nanotube layers and second carbon nanotube layers alternatively to form the carbon nanotube structure;

stamping the carbon nanotube structure to form the shutter blade 40.

In one embodiment, the carbon nanotube wires 42 are the twisted carbon nanotube wires, and the second direction is substantially perpendicular to the first direction.

It is can be noted that the shutter blade 40 can further include a coating layer coated on the surfaces of the carbon nanotube structure. The thickness of the coating layer can range from about 1 μm to about 10 μm. The material of the coating layer is substantially the same as that of the coating layer 32 of the shutter blade 30 disclosed above.

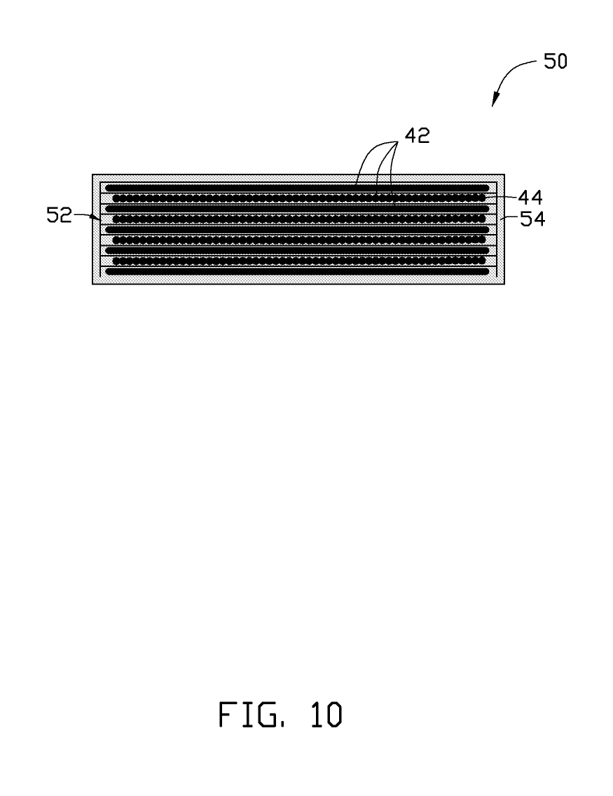

Referring to FIG. 10, a shutter blade 50 of one embodiment is provided. The shutter blade 50 is a carbon nanotube composite structure including a carbon nanotube structure 52 and a polymer 54. The carbon nanotube structure 52 includes a number of carbon nanotubes. The thickness of the shutter blade 50 can be decided by the carbon nanotube structure 52 and the polymer 54. The carbon nanotube structure 52 is about 5% to 80% by weight of the shutter blade 50. In one embodiment, the carbon nanotube structure 52 is about 10% to 30% by weight of the shutter blade 50. When the content of the carbon nanotube structure 52 is low by weight of the shutter blade 50, the carbon nanotubes in the carbon nanotube structure 52 cooperate with the polymer 54 to improve mechanical property of the shutter blade 50.

The carbon nanotube structure 52 can include the drawn carbon nanotube film, the pressed carbon nanotube film, the flocculated carbon nanotube film, the carbon nanotube wires, or any combination thereof. The carbon nanotube structure 52 can be a free-standing structure including a number of carbon nanotubes. Adjacent carbon nanotubes tightly combine with each other and define a number of micropores. Adjacent carbon nanotube wires can define a number of interspaces. The carbon nanotube structure 52 is located within the polymer 54. The polymer 54 covers on surfaces of the carbon nanotube structure 52 and fills into the micropores or the interspaces.

The polymer 54 can be thermoset or thermoplastic, such as epoxy resin, polyolefin, acrylic resin, polyamide (PA), polyurethane (PU), polycarbonate (PC), polyoxymethylene resin (POM), polyethylene terephthalate (PET), polymethyl methacrylate acrylic (PMMA), or silicone.

In one embodiment, the shutter blade 50 is a rectangle thin sheet-shaped structure, with a thickness of about 40 μm. No significant amount of light can emit through the shutter blade 50. The carbon nanotube structure 52 is about 20% by weight of the shutter blade 50. The carbon nanotube structure 52 includes a number of stacked carbon nanotube layers 42 including a number of carbon nanotube wires 44. The carbon nanotube wires 44 are substantially parallel to each other and arranged side by side. The polymer 54 is PET.

The shutter blade 50 can be made by dipping the shutter blade 40 into a monomer solution, a prepolymer solution, a liquid polymer, or coating the liquid polymer on the shutter blade 40, to form a carbon nanotube composite structure; and stamping the carbon nanotube composite structure to form the shutter blade 50.

The shutter blade 50 is formed by a predetermined proportion of the carbon nanotubes and the polymer. The carbon nanotubes and the polymer cooperately provide good mechanical properties to the shutter blades, especially when the weight of the carbon nanotubes in the shutter blades is relatively low.

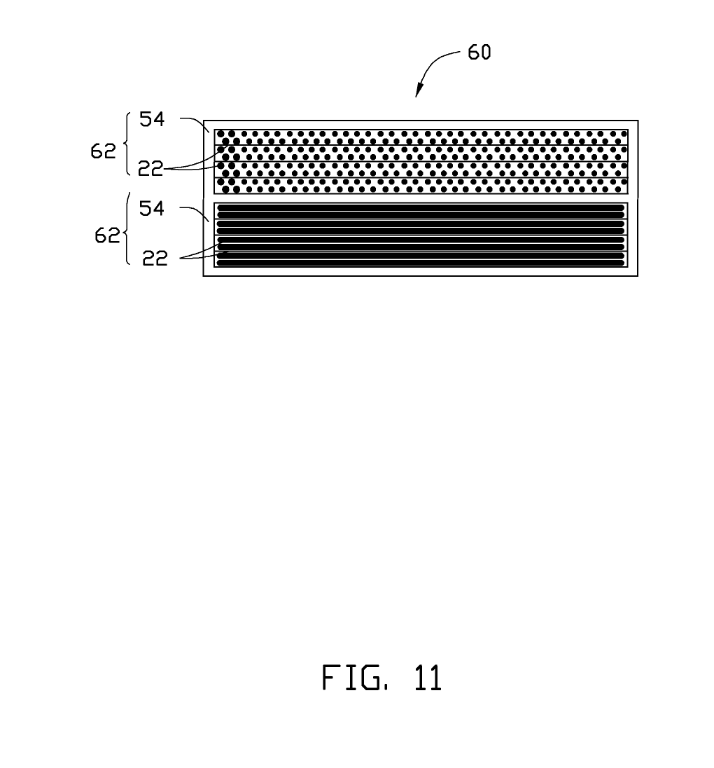

Referring to FIG. 11, a shutter blade 60 of one embodiment is provided. The shutter blade 60 includes at least two stacked carbon nanotube composite layers 62. Each carbon nanotube composite layer 62 includes the carbon nanotube structure 52 and the polymer 54. The carbon nanotube structure 52 is located in the polymer 54.

In one embodiment, the carbon nanotube structure 52 includes at least two drawn carbon nanotube films 22, the carbon nanotubes in the carbon nanotube structure 52 are substantially oriented along a same direction, thus, the carbon nanotubes in each carbon nanotube composite layer 62 are substantially oriented along a same direction; the carbon nanotubes in adjacent two carbon nanotube composite layers 62 form an angle along the carbon nanotubes oriented directions. The angle is greater than 0 degrees, equal to or less than 90 degrees. In one embodiment, the carbon nanotube structure 52 includes a plurality of carbon nanotube wires substantially parallel to each other, thus, the carbon nanotube wires in the carbon nanotube structure 52 substantially extend along a same direction. The carbon nanotube wires in two adjacent carbon nanotube composite layers form an angle along extending directions of the carbon nanotube wires. The angle ranges from larger than 0 degrees, equal to and less than 90 degrees.

In one embodiment, the shutter blade 60 includes two layers of sheet-shaped carbon nanotube composite layers 62. Each carbon nanotube composite layer 62 includes a plurality of drawn carbon nanotube films 22 substantially arranged along a same direction. Namely, the carbon nanotubes are substantially arranged along the same direction in the each carbon nanotube composite layer 62. The angle defined by the extending directions of the carbon nanotubes arranged in the two carbon nanotube composite layers 62 can be greater than 0 degrees, and less than or equal to 90 degrees. In one embodiment, the angle is about 90 degrees. The polymer 54 is epoxy resin. The polymer 54 wraps around the surfaces of the drawn carbon nanotube films 22 and fills in the micropores defined by the carbon nanotubes in the drawn carbon nanotube films 22. The thickness of the shutter blade 60 is about 30 μm. The drawn carbon nanotube films 22 are about 30% by weight of the shutter blade 60.

In one embodiment, a method for making the shutter blade 60 can include the steps of:

providing at least two carbon nanotube composite layers 62, wherein the at least two carbon nanotube composite layers 62 includes the drawn carbon nanotube films 22 and epoxy resin;

stacking at least one carbon nanotube composite layers 62 on each other, and an angle defined by the carbon nanotubes extending directions in adjacent two of the carbon nanotube composite layers 62 is about 90 degrees;

hot-pressing the stacked carbon nanotube composite layers 62; and

stamping the hot pressed carbon nanotube composite layers 62 to form the shutter blade 60.

Wherein, each carbon nanotube composite layer 62 is made by stacking the drawn carbon nanotube films 22 one by one to form the carbon nanotube structure 52 including the carbon nanotubes substantially arranged along a same direction; and dipping the carbon nanotube structure 52 into a liquid epoxy resin, or coating the liquid epoxy resin onto the carbon nanotube structure 52.

It can be understood that the surfaces of the shutter blades 50 and 60 can further include a coating layer coated on the surfaces of the polymer 54. The thickness of the coating layer can range from about 1 μm to 10 μm. The material of the coating layer is the same as that of the coating layer 32 of the shutter blade 30.

It also can be understood that the shutter blades 40, 50, or 60 can be use as the shutter blade 20 in the shutter 100.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

Depending on the embodiment, certain steps or methods described may be removed, others may be added, and the sequence of steps may be altered. It is also to be understood that the description and the claims drawn relating to a method may include some indication in reference to certain steps. However, the indication used is only to be viewed for identification purposes and not taken as a suggestion as to an order for the steps.

What is claimed is:

1. A shutter blade comprising: a carbon nanotube structure comprising a plurality of carbon nanotubes.

2. The shutter blade of claim 1, wherein the carbon nanotube structure is a free standing structure comprising the plurality of carbon nanotubes combined by van der Waals force.

3. The shutter blade of claim 1, wherein the carbon nanotube structure comprises at least one carbon nanotube film.

4. The shutter blade of claim 3, wherein each of the at least one carbon nanotube film comprises the plurality of carbon nanotubes substantially oriented along a same direction.

5. The shutter blade of claim 4, wherein adjacent carbon nanotubes oriented along the same direction are joined end-to-end by van der Waals force.

6. The shutter blade of claim 5, wherein the at least one carbon nanotube film comprises at least two carbon nanotube films stacked on each other, and an angle defined by the plurality of carbon nanotubes in adjacent carbon nanotube films ranges from about 0 degrees to about 90 degrees.

7. The shutter blade of claim 3, wherein the at least one carbon nanotube film comprises at least one section, and each section comprises the plurality of carbon nanotubes substantially arranged along a same direction and rested upon each other.

8. The shutter blade of claim 3, wherein the at least one carbon nanotube film comprises the plurality of carbon nanotubes entangled with each other.

9. The shutter blade of claim 1, wherein the carbon nanotube structure comprises at least one carbon nanotube layer, each carbon nanotube layer comprises a plurality of carbon nanotube wires substantially parallel and juxtaposed with each other, and the plurality of carbon nanotube wires comprise the plurality of carbon nanotubes.

10. The shutter blade of claim 9, wherein the at least one carbon nanotube layer comprises at least two carbon nanotube layers, an angle defined by the plurality of carbon nanotube wires in adjacent carbon nanotube layers ranges from about 0 degrees to about 90 degrees.

11. The shutter blade of claim 1, further comprising a coating layer coated on a surface of the carbon nanotube structure.

12. The shutter blade of claim 11, wherein a material of the coating layer is selected from the group consisting of fluorinated polyolefin, polyimide, polyphenylene thioether, and any combination thereof.

13. A shutter blade, comprising a carbon nanotube layer comprising a plurality of carbon nanotube wires substantially arranged along a same direction, and each of the plurality of carbon nanotube wires comprising a plurality of carbon nanotubes.

14. The shutter blade of claim 13, wherein adjacent carbon nanotubes in each of the plurality of carbon nanotube wires are joined end-to-end by van der Waals force along the same direction.

15. The shutter blade of claim 13, further comprising a coating layer that coats on surfaces of the carbon nanotube layer.

16. The shutter blade of claim 13, wherein the plurality of carbon nanotube wires are substantially parallel and juxtaposed to each other.

17. A shutter, comprising:
a substrate defining an aperture;
a connection unit located on the substrate;
a blade structure connected with the connection unit, and controlling the aperture to be covered or uncovered, the blade structure comprising at least two shutter blades, each shutter blade structure comprising a carbon nanotube structure comprising a plurality of carbon nanotubes; and
two drive units located on a same side of the substrate, and configured to drive the blade structure to rotate clockwise or counterclockwise.

18. The shutter of claim 17, wherein the plurality of carbon nanotubes are substantially oriented along a same direction.

19. The shutter of claim 17, wherein the carbon nanotube structure comprises a plurality of carbon nanotube films stacked on each other, and adjacent carbon nanotube films are combined by van der Waals force.

20. The shutter of claim 17, wherein the carbon nanotube structure comprises a plurality of carbon nanotube layers comprising a plurality of carbon nanotube wires arranged side by side, each carbon nanotube wire comprises a part of the plurality of carbon nanotubes.
